(19) United States
(12) Patent Application Publication
(10) Pub. No.: US 2003/0008032 A1
(43) Pub. Date: Jan. 9, 2003

(54) Multilane extruder system

(76) Inventors: David Bruce Walker, Meridian, ID (US); Michael M. Gallagher, Boise, ID (US)

Correspondence Address: Stuart O. Lowry, KELLY BAUERSFELD LOWRY & KELLEY, LLP, Suite 1650, 6320 Canoga Avenue, Woodland Hills, CA, 91367, US

(21) Appl. No.: 10/170,173

(22) Filed: Jun. 11, 2002

Related U.S. Application Data
(60) Provisional application No. 60/303,628, filed on Jul. 5, 2001.

(51) Int. Cl. A21C 11/10

(52) U.S. Cl. 425/377; 425/315; 425/464

(57) ABSTRACT

A multilane extruder system is provided for forming a pliable mass such as a food dough into a plurality of substantially identical elongated extruded strips, and for depositing these strips onto a conveyor for further processing such as cutting into individual strips of selected length. The extruder system comprises an extruder manifold defining a plurality of flow channels having a substantially identical cross sectional size, shape, and length. Each flow channel includes a first segment extending radially outwardly from a central plenum chamber, and connecting with a second segment extending generally radially inwardly and terminating in an extrusion die port of selected shape. The second channel segments are oriented each at a selected individual angle relative to the radial direction for delivering the extruded strips onto the underlying conveyor in a substantially uniformly and closely spaced relation.

### BACKGROUND OF THE INVENTION

This application claims the benefit of U.S. Provisional Application No. 60/303,628, filed Jul. 5, 2001.

This invention relates generally to devices and methods for shaping a pliable mass such as a food dough into elongated strips. More particularly, this invention relates to an improved extruder system for forming the pliable mass into a plurality of substantially identical elongated extruded strips, and for depositing these strips onto a conveyor for further processing such as cutting into individual strips of selected length.

French fried potato strips constitute a popular consumer food item. Such potato strips are normally prepared by cutting whole raw potatoes into individual elongated strips of selected cross sectional size and shape, and then cooking the cut strips by various processes including at least one frying step in hot oil to produce a crisp and golden-brown exterior encasing a moist and mealy interior. In one common form, French fried potato strips are partially fried, or parfried, and then frozen at a production facility for subsequent shipment to the consumer such as a restaurant or the like. The parfried product can be stored in the frozen state until finish preparation is desired, as by finish frying or by optional methods such as oven heating, microwave heating, etc.

The popularity of natural-cut French fried potato strips has led to the development of alternative food products having analogous appearance, texture, and/or taste characteristics. In this regard, a variety of such alternative food products have been produced from a pliable dough mass based upon food products such as potato-based dough, corn-based dough, and others. See, for example, U.S. Pat. No. 4,293,583 which describes a potato-based dough, and WO 01/08499 A1, published Feb. 8, 2001, which describes a corn-based dough. In these products, the dough mass is formed into elongated dough strips having a cross sectional size and shape similar to a natural-cut French fry potato strip, whereupon the dough strips are then cut into relatively short individual pieces each having a length to emulate a natural-cut French fry potato strip. The thus-formed and thus-cut strips can then be processed by various steps which may include frying in hot oil.

To produce dough-based strips in production quantities, it is necessary to form a large plurality of dough strips on a concurrent basis for further production processing such as cutting and parfrying prior to freezing for shipment and/or storage. In this regard, extrusion forming equipment has been developed for extruding a food-based dough into multiple elongated strips deposited in parallel onto a conveyor for transporting the extruded strips to subsequent processing stations. See, for example, U.S. Pat. Nos. 4,302,478; 4,124,339; 4,614,489; 5,536,517; 5,668,540; 5,840,346; and 5,820,911. However, in general terms, such extrusion equipment has been relatively complex and costly. In addition, such extrusion equipment has not satisfactorily produced parallel extruded strips of substantially uniform or identical physical characteristics. That is, the resultant extruded strips have suffered from localized variations in strip cross section and/or dough material density to produce an unsatisfactory strip appearance. Moreover, especially when multiple strips are extruded in parallel onto a conveyor in closely spaced relation, variations in strip cross section such as localized bulges or thinned-out regions can cause adjacent extruded strips to contact each other and stick together, thereby disrupting subsequent processing and/or resulting in the production of undesired multi-strip clumps.

There exists, therefore, a significant need for further improvements in and to extrusion devices and methods for producing multiple extruded strips formed from a food dough or the like, particularly wherein the improved extrusion system has a relatively simple construction for consistent production of substantially identical extruded strips which can be deposited onto a conveyor or the like in closely spaced relation without contacting each other. The present invention fulfills these needs and provides further related advantages.

### SUMMARY OF THE INVENTION

In accordance with the invention, an improved multilane extruder system is provided for forming a pliable mass such as a food dough into a plurality of substantially identical elongated extruded strips, and for depositing these strips onto a conveyor in closely spaced relation for further processing such as cutting into individual strips of selected length. The extruder system comprises an extruder manifold defining a central plenum chamber for receiving a pressure-forced flow of the pliable mass, for flow passage from the plenum chamber through a plurality of elongated flow channels having a substantially identical cross sectional size, shape, and length.

In the preferred form, each flow channel formed within the extruder manifold includes a plurality of first channel segments having a substantially identical cross sectional size and shape, and a substantially identical length extending radially outwardly from the central plenum chamber. The outermost ends of these first channel segments are each connected via a respective axially open transition aperture with an associated one of a plurality of second channel segments. These second channel segments also have a substantially identical cross sectional size and shape, and a substantially identical length extending generally radially inwardly and terminating at an extrusion die port of selected size and cross sectional shape. The second channel segments are oriented each at a selected and individual angle relative to the radial direction for delivering the extruded strips onto the underlying conveyor in a substantially uniformly and closely spaced relation.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is fragmented and somewhat schematic perspective view illustrating a multilane extruder system embodying the novel features of the invention;

FIG. 2 is an enlarged perspective showing an exemplary extruded dough strip produced by the multilane extruder system and cut lengthwise to simulate the appearance of a natural-cut French fry potato strip;

FIG. 3 is an enlarged and fragmented side elevation view of an extruder manifold, taken generally on the line 3-3 of FIG. 1;

FIG. 4 is an enlarged and fragmented vertical sectional view of the extruder manifold;

FIG. 5 is a top plan view of an upper extrusion die plate of the extruder manifold;

FIG. 6 is a top plan view of a lower extrusion die plate of the extruder manifold;

FIG. 7 is a bottom plan view of a lower end plate of the extruder manifold; and

FIG. 8 is a schematic diagram illustrating combined product flow paths defined by the assembled upper and lower extrusion die plates, in operative relation with an underlying conveyor.

### DETAILED DESCRIPTION OF THE PREFERRED EMBODIMENT

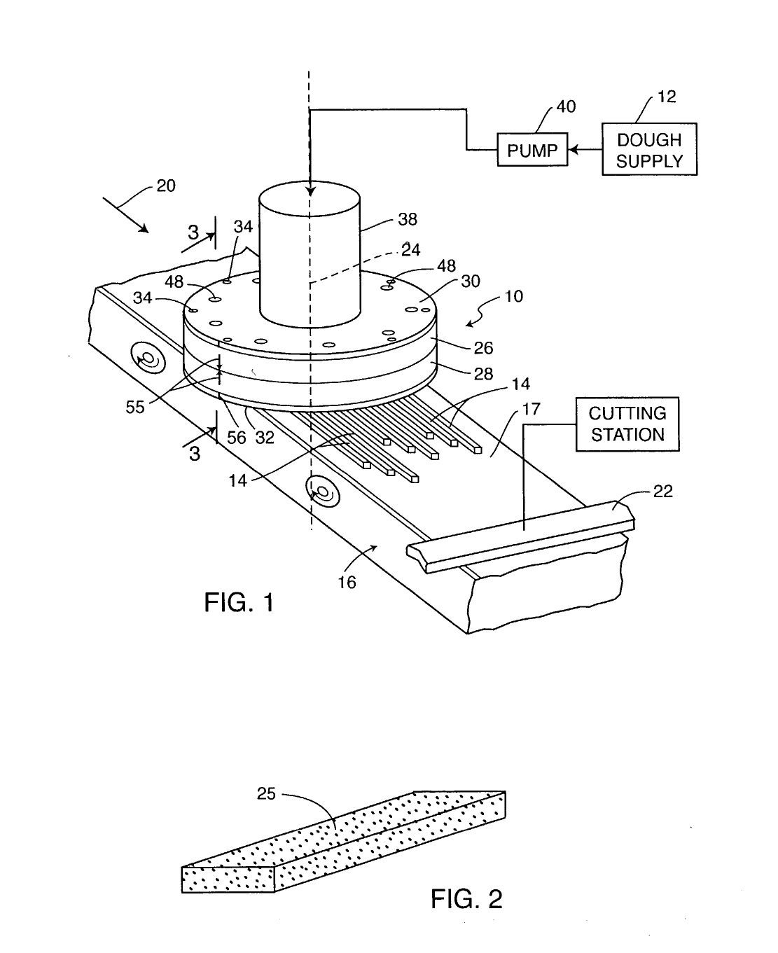

As shown in the exemplary drawings, an improved multilane extruder system referred to generally by the reference numeral 10 in FIG. 1 is provided for forming a pliable mass such as a food dough 12 into a plurality of substantially identical elongated extruded strips 14, and for depositing these strips 14 onto a conveyor 16 in closely spaced relation for further processing such as cutting into individual strips of selected length. The extruder system 10 comprises an extruder manifold 18 mounted over the conveyor 16 and defining a plurality of elongated internal flow channels (FIGS. 4-8) having a substantially identical cross sectional size, shape, and length for producing the substantially identical extruded strips 14. In accordance with a primary aspect of the invention, these internal flow channels have a substantial channel length yet incorporate directional changes to provide a high degree of strip uniformity, so that the plurality of extruded strips 14 can be deposited onto the underlying conveyor 16 in closely spaced relation with little or no risk of adjacent strips contacting each other and/or sticking together on the conveyor 16.

The multilane extruder system 10 of the present invention is particularly designed for handling a food-based dough 12 such as a potato-based or a corn-based dough of the type used in making a food product having an appearance emulating natural-cut French fried potato strips. In this regard, the illustrative extruded strips 14 deposited onto the conveyor 16 are shown to have a generally square cross sectional shape of selected dimensions to correspond with the cross sectional size and shape of natural-cut French fried potato strips, such as so-called shoestring size strips having substantially square-cut sides of about 0.30 inch. FIG. 1 shows the extruded strips 14 deposited onto a conveyor belt 17 in closely-spaced parallel relation for conveyance in the direction of arrow 20 to a subsequent processing station such as a cutting station 22. At the cutting station, suitable means (not shown) are provided for cutting each of the elongated extruded strips 14 into a succession of individual strips pieces 25 (shown by way of example in FIG. 2), wherein each strip piece 25 is desirably cut angularly at each end, and at an appropriate length or distribution of lengths typically within a 2-6 inch range, to provide a large plurality of strip pieces 25 having a geometrical shape closely simulating natural-cut French fried potato strips. These cut pieces 25 are then suitably transported to one or more subsequent processing stations (not shown) for additional processing such as parfrying, freezing, and the like.

FIG. 1 shows the extruder manifold 18 mounted over the conveyor belt 17 in relatively closely spaced, overlying relation thereto. The illustrative extruder manifold 18 has a generally cylindrical configuration oriented with a central axis 24 thereof extending generally vertically with respect to a transverse midpoint of the horizontally oriented conveyor belt. The diametric size of the extruder manifold 18 exceeds the width of the conveyor belt 17, with the internal flow channels (to be described) incorporating directional changes so that each flow channel has a substantial overall length yet the multiple flow channels terminate in closely and uniformly spaced relation over the conveyor belt 17 for depositing the extruded strips 14 across the width of the said belt 17 in closely and uniformly spaced relation.

More particularly, the extruder manifold 18 comprises a manifold housing constructed from a stacked pair of upper and lower extrusion die plates 26 and 28 assembled in sandwiched relation between an upper end plate 30 and a lower end plate 32. This stacked assembly is conveniently retained by means of a plurality of bolts 34 extending therethrough in an array about the manifold periphery. The upper end plate 30 defines a relatively large and centrally positioned inlet 36 (FIG. 4) for receiving a flow of the pliable food-based dough mass delivered under pressure through a supply conduit 38 by a pump 40 (FIG. 1) from a dough supply. In this regard, a downstream end of the supply conduit 38 is suitably attached to the upper end plate 30.

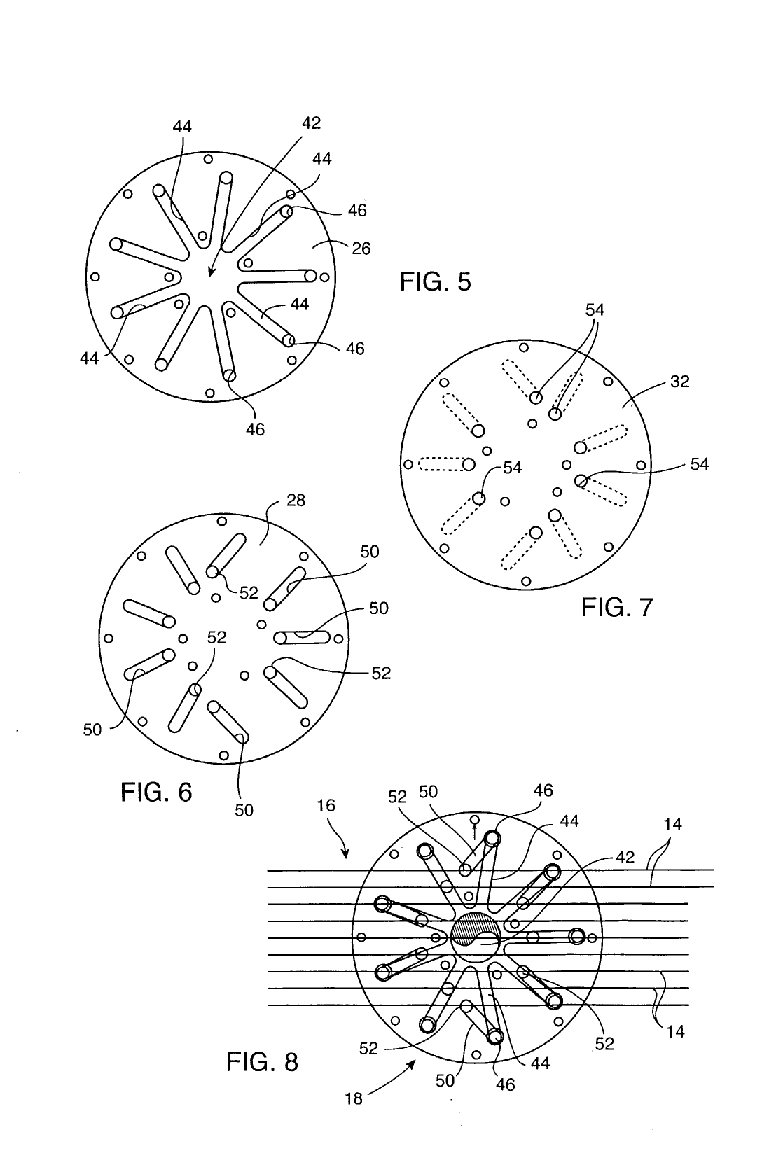

The upper extrusion die plate 26 is shown in more detail in FIGS. 4-5. As shown, this upper die plate 26 defines an upwardly open central plenum chamber 42 disposed in alignment with the downstream end of the supply conduit 38 for receiving the dough 12 pumped to the extruder manifold 18. This upwardly open plenum chamber 42 communicates with an upstream end of the plurality of internal flow channels. In particular, the plenum chamber 42 communicates with a plurality of radially outwardly extending first channel segments 44 which are formed with an upwardly open configuration by the upper die plate 26, and the upper ends of which are closed by the overlying upper end plate 30. The radially outermost ends of these first channel segments 44 communicate downwardly through the upper die plate 26 via short direction changing transition segments or apertures 46 of substantially identical size and shape. If desired, a throttling screw 48 (FIG. 4) fastened downwardly through the upper end plate 30 may be provided at the outer end of each first channel segment 44, with a screw tip projecting into the associated channel segment 44, to permit individual and close throttling adjustment of the dough 12 pumped therethrough.

In the preferred form of the invention, the cross sectional size and shape, and the length of the multiple channel segments 44 formed by the upper die plate 26 are substantially identical. The dough 12 is pumped under pressure to the plenum chamber 42, whereby the dough is subdivided into multiple flows subjected to a common upstream pressure for passage through the first channel segments 44. Importantly, while the illustrative drawings show a plurality of nine first channel segments 44 projecting radially outwardly in an equiangularly spaced array from the central plenum chamber 42, it will be recognized and appreciated that any selected number of first channel segments 44 may be employed to produce a corresponding number of extruded strips 14 delivered ultimately to the conveyor 16.

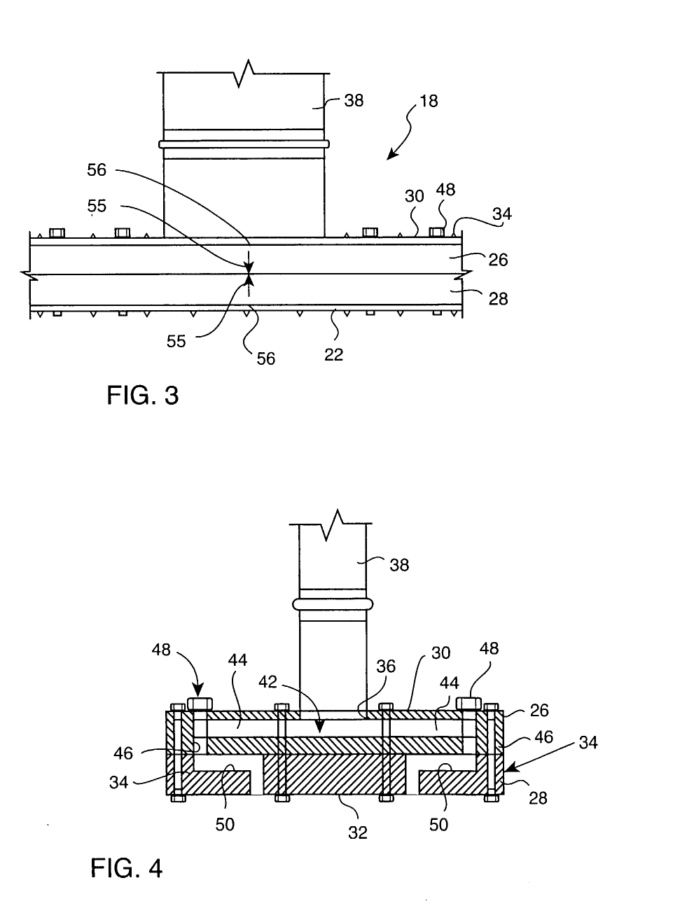

FIGS. 4 and 7 show the configuration of the lower extrusion die plate 28. As shown, this lower die plate 28 defines a plurality of second flow channel segments 50 having outermost ends communicating respectively through the transition apertures 46 with the overlying first channel segments 44 in the upper die plate 26. These second channel segments 50 are upwardly open within the lower die plate 28, with their upper ends being closed by the overlying upper die plate 26 mounted thereon. The individual second channel segments 50 have a substantially identical cross sectional size and shape which preferably conforms to the cross sectional size and shape of the first channel segments 44. In addition, the second channel segments 50 have a substantially identical length, each terminating at a downstream end in a downwardly open discharge port 52 disposed in respective alignment with a downwardly open extrusion die port 54 of selected size and shape formed in the underlying lower end plate 32 of the assembled manifold structure. In the preferred embodiment as shown (FIG. 7), the extrusion ports 54 have a square cross sectional shape for forming the individual extruded strips 14 of square cross sectional shape. Conveniently, the peripheral margins of the extrusion die plates 26, 28 include markings or indicia 55 (FIG. 3), and the peripheral margins of the end plates 30, 32 include similar types of markings or indicia 56 (FIG. 3) for facilitated stacked assembly of these manifold components in the correct orientation or alignment with each other.

In accordance with one primary aspect of the invention, the plurality of second channel segments 50 formed in the lower die plate 28 extend generally radially inwardly from the associated transition apertures 46 at different selected angular orientations relative to a radial direction of the extrusion manifold 18, so that the plurality of extrusion die ports 54 are positioned in closely spaced relation with respect to a transverse axis of the underlying conveyor 16. That is, as viewed best in FIG. 8, the dough 12 is pumped through the first channel segments 44 radially outwardly from the central plenum chamber 42 through a relatively extended length path terminating at the transition apertures 46 at a diametric position exceeding the width of the conveyor belt 17. The dough then travels generally radially inwardly through the second channel segments 50 which are individually angularly set relative to a radius of the manifold 18 to terminate at the extrusion die ports 54 for delivering the multiple extruded dough strips 14 onto the conveyor belt 17 with a relatively close inter-strip spacing that is substantially uniform across the width of the belt 17. FIG. 7 shows the square-sided extrusion die ports 54 individually oriented with their flat sides extending parallel and perpendicular to the direction of belt travel for smoothly depositing the extruded strips 14 onto the belt 17 with one strip flat side seating firmly and flushly onto the belt.

The multilane extruder system 10 of the present invention thus provides a relatively simple and highly effective apparatus for producing multiple elongated extruded strips 14 of dough or the like for further processing. The extruded strips 14 exhibit a high degree of uniform characteristics including cross sectional size and shape and related product density, substantially without localized discontinuities such as thinned or bulged regions which can otherwise impede a desirably smooth and consistent deposit of the closely spaced strips onto the underlying conveyor.

A variety of modifications and improvements in and to the multilane extruder system of the present invention will be apparent to those persons skilled in the art. For example, while the flow channels formed in the extruder manifold 10 are shown and described as extending radially outwardly and then turning radially inwardly, it will be understood that a variety of channel shapes extending outwardly, inwardly, or a combination thereof may be used. In addition, it will be further recognized and appreciated that the extruded strips 14 may have alternative cross sectional shapes such as round, rectangular, trapezoidal, triangular, and others. Accordingly, no limitation on the invention is intended by way of the foregoing description and accompanying drawings, except as set forth in the appended claims.

What is claimed is:

1. An extruder manifold for extruding a pliable mass into a plurality of substantially identical elongated strips, said extruder manifold comprising:
a manifold housing defining a plenum chamber for receiving a pressure-forced flow of the pliable mass;
said manifold housing further defining a plurality of elongated flow channels of substantially identical length, each of said flow channels having a first channel segment coupled in flow communication between said plenum chamber and a direction changing transition segment, and a second channel segment coupled in flow communication between said transition segment and an extrusion die port.

2. The extruder manifold of claim 1 wherein the pliable mass comprises a food dough.

3. The extruder manifold of claim 1 wherein said first channel segments of said plurality of flow channels have a substantially identical length, and a substantially identical cross sectional size and shape.

4. The extruder manifold of claim 3 wherein said second channel segments of said plurality of flow channels have a substantially identical length, and a substantially identical cross sectional size and shape.

5. The extruder manifold of claim 4 wherein said first and second channel segments have substantially identical cross sectional size and shape.

6. The extruder manifold of claim 4 wherein said transition channel segments have a substantially identical cross sectional size and shape.

7. The extruder manifold of claim 1 wherein said extrusion die ports have a substantially identical cross sectional size and shape.

8. The extruder manifold of claim 1 further including a throttling screw extending adjustably into each of said transition segments for individually adjusting the flow of the pliable mass therethrough.

9. The extruder manifold of claim 1 wherein each of said first channel segments extends generally radially outwardly from said plenum chamber, and further wherein each of said second channel segments extends generally radially inwardly from said plenum chamber.

10. The extruder manifold of claim 9 wherein said second channel segments extend at different selected angular orientations relative to a radial direction.

11. An extruder manifold for extruding a pliable mass into a plurality of substantially identical elongated strips, said extruder manifold comprising:
a manifold housing defining a plenum chamber for receiving a pressure-forced flow of the pliable mass;
said manifold housing further defining a plurality of elongated flow channels of substantially identical cross sectional size and shape, said flow channels each including a first channel segment of substantially identical length coupled in flow communication between said plenum chamber and a direction changing transition segment, and a second channel segment of substantially identical length coupled in flow communication between said transition segment and an extrusion die port of substantially identical cross sectional size and shape.

12. The extruder manifold of claim 11 wherein the pliable mass comprises a food dough.

13. The extruder manifold of claim 11 further including a throttling screw extending adjustably into each of said transition segments for individually adjusting the flow of the pliable mass therethrough.

14. The extruder manifold of claim 11 wherein each of said first channel segments extends generally radially outwardly from said plenum chamber, and further wherein each of said second channel segments extends generally radially inwardly from said plenum chamber.

15. The extruder manifold of claim 14 wherein said second channel segments extend at different selected angular orientations relative to a radial direction.

16. A multilane extrusion system extruding a pliable mass into a plurality of elongated strips, said system comprising:
an extrusion manifold defining a plenum chamber for receiving a pressure-forced flow of the pliable mass, said extrusion manifold further defining a plurality of elongated flow channels substantially identical length, each of said flow channels having a first channel segment coupled in flow communication between said plenum chamber and a direction changing transition segment, and a second channel segment coupled in flow communication between said transition segment and an extrusion die port;
pump means for delivering a supply of a pliable mass to said plenum chamber, whereby the pliable mass is pressure-forced to flow from said plenum chamber through each of said flow channels and further to extrude through each of said extrusion die ports to form a plurality of extruded elongated strips; and
conveyor means for receiving and conveying said extruded elongated strips.

17. The multilane extrusion system of claim 16 wherein the pliable mass comprises a food dough.

18. The multilane extrusion system of claim 16 wherein said first channel segments of said plurality of flow channels have a substantially identical length, and a substantially identical cross sectional size and shape, and further wherein said second channel segments of said plurality of flow channels have a substantially identical length, and a substantially identical cross sectional size and shape corresponding to the cross sectional size and shape of said first channel segments.

19. The multilane extrusion system of claim 18 wherein said transition channel segments have a substantially identical cross sectional size and shape.

20. The multilane extrusion system of claim 18 wherein said extrusion die ports have a substantially identical cross sectional size and shape.

21. The multilane extrusion system of claim 18 further including a throttling screw extending adjustably into each of said transition segments for individually adjusting the flow of the pliable mass therethrough.

22. The multilane extrusion system of claim 16 wherein each of said first channel segments extends generally radially outwardly from said plenum chamber, and further wherein each of said second channel segments extends generally radially inwardly from said plenum chamber.

23. The multilane extrusion system of claim 22 wherein said extrusion manifold is mounted over said conveyor means and has a generally cylindrical configuration oriented with a central axis thereof extending generally vertically with respect to a transverse midpoint of said conveyor means, said extrusion manifold having a diametric size greater than the width of said conveyor means.

24. The multilane extrusion system of claim 23 wherein said second channel segments extend at different selected angular orientations relative to a radial direction for depositing said extruded elongated strips onto said conveyor means in closely spaced and substantially parallel relation.
